(19) United States
(12) Patent Application Publication
(10) Pub. No.: US 2023/0362810 A1
(43) Pub. Date: Nov. 9, 2023

(54) POWER CONSUMPTION CALCULATION AND REPORTING

(71) Applicant: QUALCOMM Incorporated, San Diego, CA (US)

(72) Inventors: Mickael MONDET, Louannec (FR); Prashanth Haridas HANDE, San Diego, CA (US); Hyun Yong LEE, San Diego, CA (US); Sanket Sanjay KALAMKAR, San Diego, CA (US)

(21) Appl. No.: 17/662,526

(22) Filed: May 9, 2022

(51) Int. Cl. H04W 52/02

(52) U.S. Cl. CPC H04W 52/0212

(57) ABSTRACT

Various aspects of the present disclosure generally relate to wireless communication. In some aspects, a user equipment (UE) may determine, using a modem of the UE, an estimated power consumption of the modem. The UE may provide, using the modem, an indication of the estimated power consumption to an application processor of the UE. Numerous other aspects are described.

### FIELD OF THE DISCLOSURE

Aspects of the present disclosure generally relate to wireless communication and to techniques and apparatuses for power consumption calculation and reporting.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include determining, using a modem of the UE, an estimated power consumption of the modem. The method may include providing, using the modem, an indication of the estimated power consumption to an application processor of the UE.

Some aspects described herein relate to a UE for wireless communication. The user equipment may include a memory and one or more processors coupled to the memory. The one or more processors may be configured to determine, using a modem of the UE, an estimated power consumption of the modem. The one or more processors may be configured to provide, using the modem, an indication of the estimated power consumption to an application processor of the UE.

Some aspects described herein relate to a non-transitory computer-readable medium that stores a set of instructions for wireless communication by a UE. The set of instructions, when executed by one or more processors of the UE, may cause the UE to determine, using a modem of the UE, an estimated power consumption of the modem. The set of instructions, when executed by one or more processors of the UE, may cause the UE to provide, using the modem, an indication of the estimated power consumption to an application processor of the UE.

Some aspects described herein relate to an apparatus for wireless communication. The apparatus may include means for determining, using a modem of the apparatus, an estimated power consumption of the modem. The apparatus may include means for providing, using the modem, an indication of the estimated power consumption to an application processor of the apparatus.

Aspects generally include a method, apparatus, system, computer program product, non-transitory computer-readable medium, user equipment, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example of devices designed for periodic multimedia traffic applications, in accordance with the present disclosure.

FIG. 4 is a diagram illustrating an example of communication flows between a UE and an application server, in accordance with the present disclosure.

FIG. 5 is a diagram illustrating an example associated with power consumption calculation and reporting, in accordance with the present disclosure.

FIG. 6 is a diagram illustrating an example process associated with power consumption calculation and reporting, in accordance with the present disclosure.

FIG. 7 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

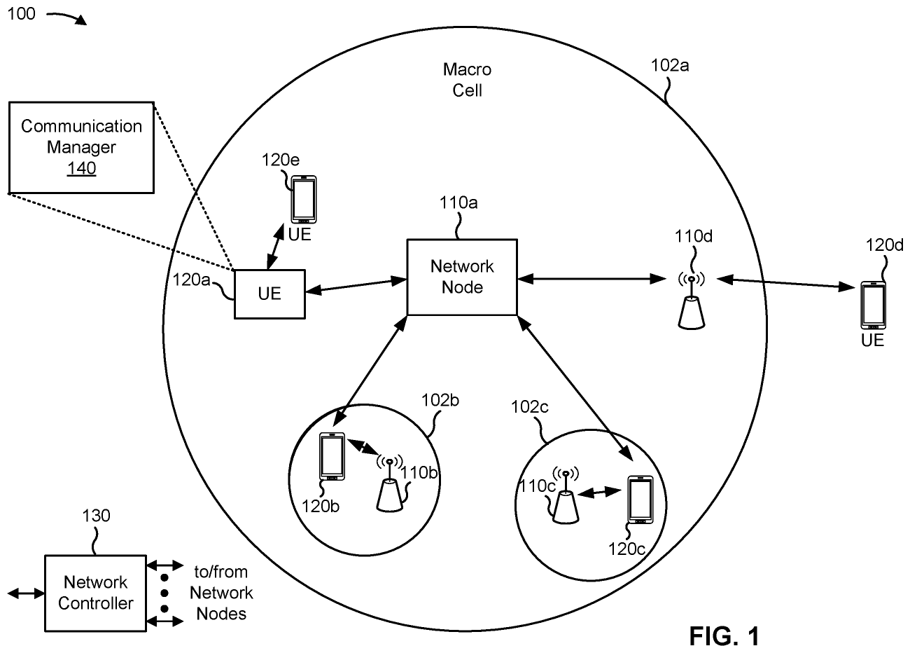

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other network entities. A network node 110 is an entity that communicates with UEs 120. A network node 110 may include, for example, a base station (sometimes referred to as a BS), an NR base station, an LTE base station, a Node B, an eNB (e.g., in 4G), a gNB (e.g., in 5G), an access point, and/or a transmission reception point (TRP). Each network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used.

A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico base station. A network node 110 for a femto cell may be referred to as a femto base station or an in-home base station. In the example shown in FIG. 1, the network node 110a may be a macro base station for a macro cell 102a, the network node 110b may be a pico base station for a pico cell 102b, and the network node 110c may be a femto base station for a femto cell 102c. A network node may support one or multiple (e.g., three) cells.

In some examples, a cell may not necessarily be stationary, and the geographic area of the cell may move according to the location of a network node 110 that is mobile (e.g., a mobile base station). In some examples, the network nodes 110 may be interconnected to one another and/or to one or more other network nodes 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a network node 110 or a UE 120) and send a transmission of the data to a downstream station (e.g., a UE 120 or a network node 110). A relay station may be a UE 120 that can relay transmissions for other UEs 120. In the example shown in FIG. 1, the network node 110d (e.g., a relay base station) may communicate with the network node 110a (e.g., a macro base station) and the UE 120d in order to facilitate communication between the network node 110a and the UE 120d. A network node 110 that relays communications may be referred to as a relay station, a relay base station, a relay, or the like.

The wireless network 100 may be a heterogeneous network that includes network nodes 110 of different types, such as macro base stations, pico base stations, femto base stations, relay base stations, or the like. These different types of network nodes 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

Deployment of communication systems, such as 5G New Radio (NR) systems, may be arranged in multiple manners with various components or constituent parts. In a 5G NR system, or network, a network node, a network entity, a mobility element of a network, a radio access network (RAN) node, a core network node, a network element, a base station, or a network equipment may be implemented in an aggregated or disaggregated architecture. For example, a base station (such as a Node B (NB), evolved NB (eNB), NR base station (BS), 5G NB, gNodeB (gNB), access point (AP), transmit receive point (TRP), or cell), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station may be configured to utilize a radio protocol stack that is physically or logically integrated within a single RAN node (for example, within a single device or unit). A disaggregated base station may be configured to utilize a protocol stack that is physically or logically distributed among two or more units (such as one or more CUs, one or more DUs, or one or more RUs). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU, and RU also may be implemented as virtual units (e.g., a virtual central unit (VCU), a virtual distributed unit (VDU), or a virtual radio unit (VRU)).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that may be individually deployed. A disaggregated base station may include functionality implemented across two or more units at various physical locations, as well as functionality implemented for at least one unit virtually, which may enable flexibility in network design. The various units of the disaggregated base station may be configured for wired or wireless communication with at least one other unit of the disaggregated base station.

A network controller 130 may couple to or communicate with a set of network nodes 110 and may provide coordination and control for these network nodes 110. The network controller 130 may communicate with the network nodes 110 via a backhaul communication link. The network nodes 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may determine, using a modem of the UE, an estimated power consumption of the modem; and provide, using the modem, an indication of the estimated power consumption to an application processor of the UE. Additionally, or alternatively, the communication manager 140 may perform one or more other operations described herein.

As indicated above, FIG. 1 is provided as an example. Other examples may differ from what is described with regard to FIG. 1.

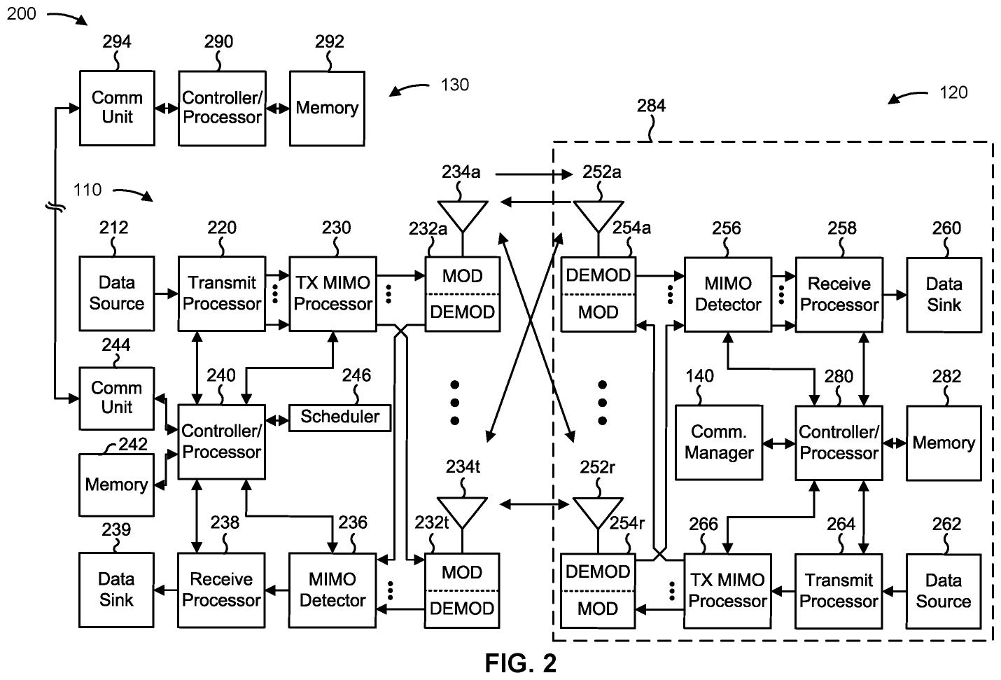

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1).

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

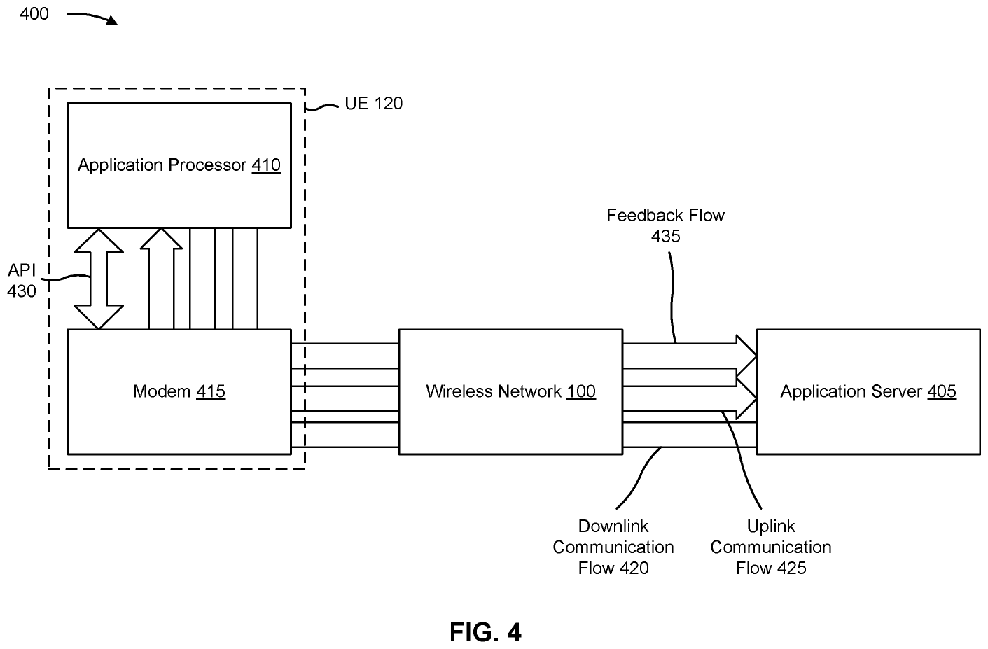

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 4-7).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 4-7).

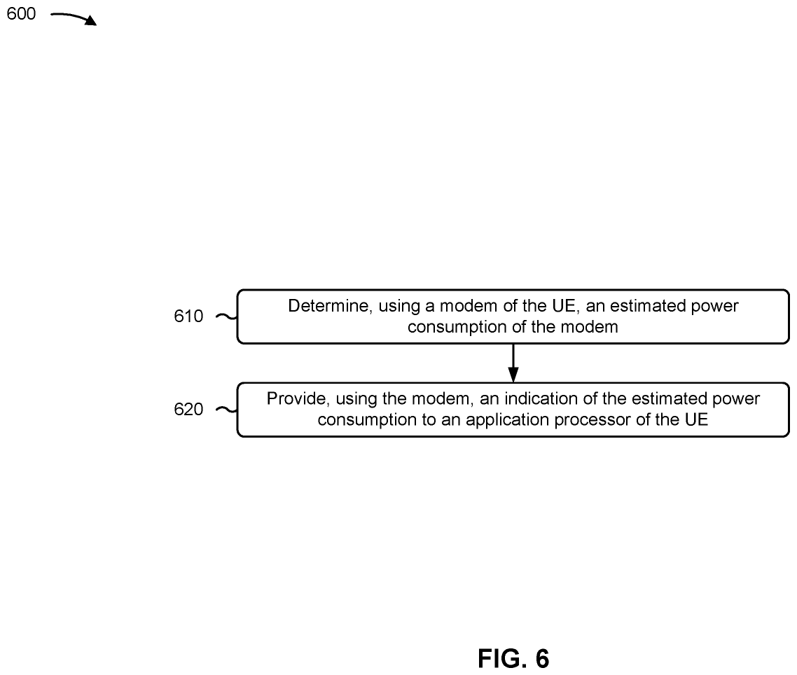

The controller/processor 240 of the network node 110, the controller/processor 280 of the UE 120, and/or any other component(s) of FIG. 2 may perform one or more techniques associated with power consumption calculation and reporting, as described in more detail elsewhere herein. For example, the controller/processor 240 of the network node 110, the controller/processor 280 of the UE 120, and/or any other component(s) of FIG. 2 may perform or direct operations of, for example, process 600 of FIG. 6 and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 600 of FIG. 6 and/or other processes as described herein. In some examples, executing instructions may include running the instructions, converting the instructions, compiling the instructions, and/or interpreting the instructions, among other examples.

In some aspects, the UE 120 includes means for determining, using a modem of the UE 120, an estimated power consumption of the modem 254; and/or means for providing, using the modem 254, an indication of the estimated power consumption to an application processor (e.g., the controller/processor 280 and/or another controller/processor) of the UE 120. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

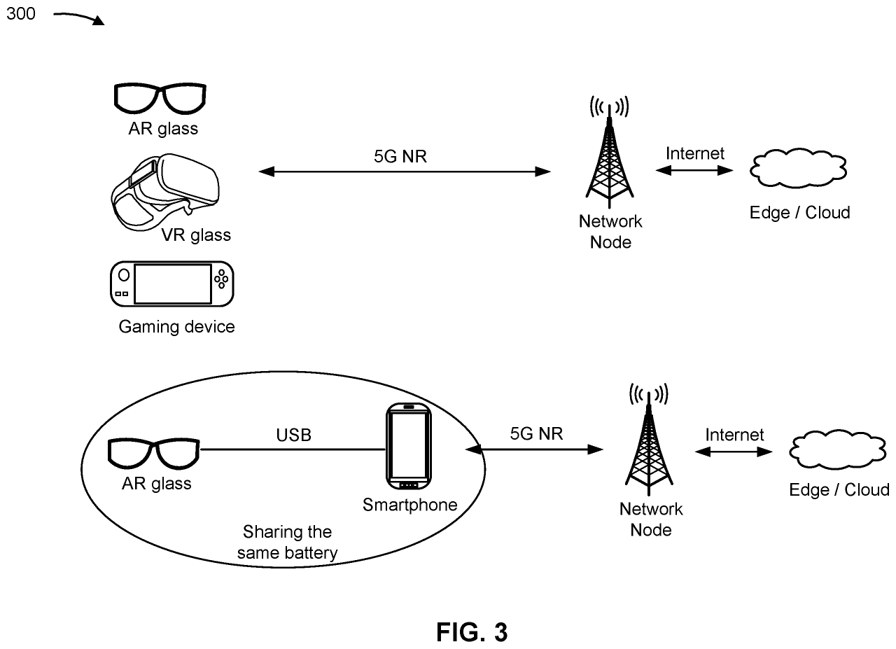

FIG. 3 is a diagram illustrating an example 300 of devices designed for periodic multimedia traffic applications, in accordance with the present disclosure.

Some devices, including devices for extended reality (XR) and/or gaming, may require low-latency traffic to and from an edge server or a cloud environment. The traffic to and from the edge server or the cloud environment may be periodic, to support a particular frame rate (e.g., 120 frames per second (FPS), 90 FPS, 60 FPS) and/or a particular refresh rate (e.g., 500 Hertz (Hz), 120 (Hz)) for multimedia traffic applications such as XR and/or gaming.

An XR device may include a UE 120 or may be associated with a UE 120. XR devices, gaming devices, and similar types of devices may execute or may be associated with an application. The application may be executed by an application processor of an associated UE and/or by an XR device or for another type of gaming device). Applications for an XR device (or for another type of gaming device such as a UE 120) may include a video game (e.g., where multimedia traffic is transferred to and from an edge server or a cloud environment at a particular frame rate to support audio and/or video rendering) and/or a VR environment (e.g., where multimedia traffic is transferred to and from an edge server or a cloud environment at a particular polling rate to support sensor (e.g., 6 degrees of freedom (6DOF) sensor input and feedback), among other examples.

Example 300 shows communications between an XR device and the edge server or the cloud environment, via a network node (e.g., a gNB, a network node 110, and/or another type of network entity described in connection with FIG. 3). The XR device may be an augmented reality (AR) glasses device, a virtual reality (VR) glass device, or other gaming device. XR devices may have limited battery capacity while being expected to have a battery life of a smartphone (e.g., full day of use). Battery power is an issue even when the XR device is tethered to a smartphone and uses the same smartphone battery. XR device power consumption and dissipation may be limited and may lead to an uncomfortable user experience and/or a short battery life. Thus, excessive power consumption associated with an application that is executed by an application processor of a UE and/or by an application processor of an associated XR device may result in decreased battery life for the UE and/or the associated XR device, may result in reduced comfort resulting from increased heat that is generated by the UE and/or the associated XR device, and/or may result in reduced usage times (e.g., reduced gaming session times, reduced VR session times) for the application, among other examples.

Some implementations described herein provide power consumption calculation and reporting for a UE and/or an associated XR device. As described herein, an application programming interface (API) may be provided between an application processor and a modem (e.g., of a UE 120, of an XR device). The API enables direct communication between the application processor and the modem, which enables commands and power consumption reports to be provided directly between the application processor and the modem. The API enables the application processor to be “modem power aware” in that the modem may provide power consumption reports to the application processor via the API so that the application processor is aware of the modem's power consumption (estimated/predicted or actual) associated with a particular application. The modem may determine an overall estimated power consumption of the modem, a per-flow estimated power consumption (e.g., a power consumption for a specific communication flow associated with an application), a predicted power consumption for a candidate or proposed communication flow, and/or another type of power consumption report, among other examples. The power consumption reports provided by the modem to the application processor enable the application processor to adjust one or more parameters associated with the application to achieve a desired battery life and/or user experience of the UE and/or the XR device, and/or to extend or prolong the remaining battery life of the UE and/or the XR device, among other examples.

As indicated above, FIG. 3 is provided as an example. Other examples may differ from what is described with regard to FIG. 3.

FIG. 4 is a diagram illustrating an example 400 of communication flows between a UE 120 and an application server 405, in accordance with the present disclosure. The UE 120 may include an XR device described in connection with FIG. 3 and/or may be associated with an XR device.

The UE 120 may communicate with an application server 405 via the wireless network 100. The application server 405 may host an application such as a gaming application, a video streaming application, an XR, VR, or AR application, and/or another type of application for which communication flows of streaming data are provided between the UE 120 and the application server 405. The application server 405 may be included in an edge server, a cloud environment, and/or another type of server environment.

The UE 120 may include an application processor 410 and a modem 415. The application processor 410 may correspond to the controller/processor 280 of FIG. 2 and/or another controller/processor of the UE 120. The modem 415 may correspond to the modem 254, the receive processor 258, and/or the transmit processor 264 of FIG. 2, and/or another modem component.

The application processor 410 may be configured to execute a client of the application hosted by the application server 405. Communication flows associated with the application may be provided to and received from the application server 405 through the modem 415 and the wireless network 100. A communication flow associated with the application may include a directional data stream associated with the application. An application may be associated with a downlink communication flow 420 and an uplink communication flow 425. The downlink communication flow 420 may include a data stream from the application server 405 to the application processor 410, whereas the uplink communication flow 425 may include a data stream from the application processor 410 to the application server 405. The downlink communication flow 420 and the uplink communication flow 425 may include application data such as a video stream, gaming data, XR/VR/AR pose data, sensor data, and/or other types of data associated with the application.

As further shown in FIG. 4, the UE 120 may include an API directly between the application processor 410 and the modem 415. The API enables direct communication between the application processor 410 and the modem 415. As described herein, the modem 415 may provide power consumption reports to the application processor 410. A power consumption report may include an indication of a power consumption (e.g., estimated, predicted, and/or actual) of the modem 415. A power consumption report may be associated with the application and/or the communication flows associated with the application.

The application processor 410 may use the power consumption reports to provide client feedback to the application server 405 in a feedback flow 435. For example, the application processor 410 may provide, via the feedback flow 435, an indication to reduce a data transfer rate associated with the application, an indication to reduce a display resolution associated with the application, and/or an indication to modify another parameter of the application to reduce power consumption of the modem 415. In this way, the power consumption reports, the API 430, and the feedback flow 435 enable the UE 120 to reduce the power consumption of the modem 415 to extend the battery life of the UE 120 and or to provide an appropriate user experience for the application.

As indicated above, FIG. 4 is provided as an example. Other examples may differ from what is described with regard to FIG. 4.

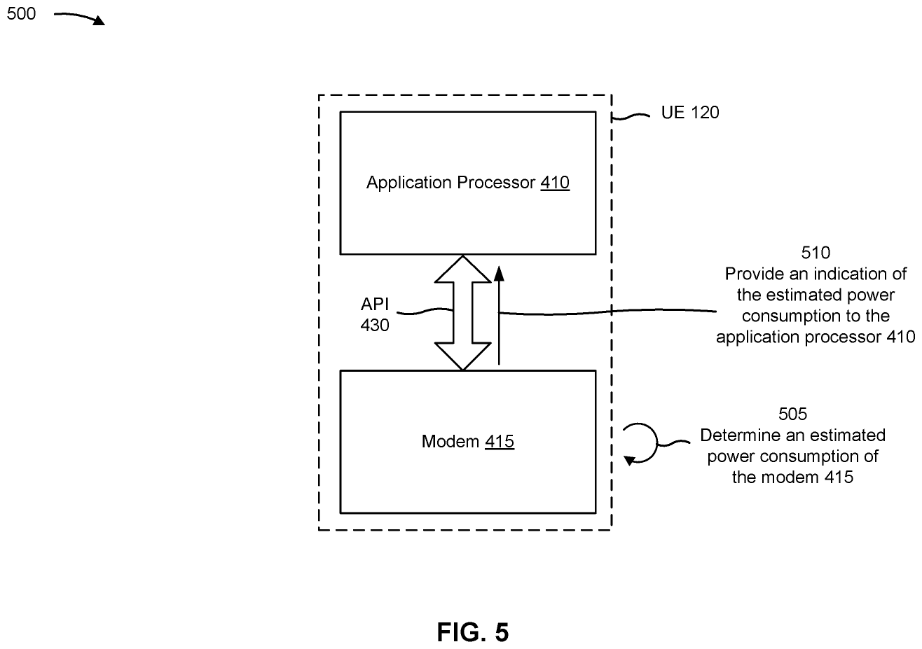

FIG. 5 is a diagram illustrating an example 500 associated with power consumption calculation and reporting, in accordance with the present disclosure. The example 500 may include operations that are performed by a UE 120. The UE 120 may include an XR device described in connection with FIG. 3 and/or may be associated with an XR device.

As shown in FIG. 5, at 505, the modem 415 of the UE 120 may determine an estimated power consumption of the modem 415. The estimated power consumption may include an overall estimated power consumption of the modem 415, a per-flow estimated power consumption (e.g., a power consumption for a specific communication flow associated with an application), a predicted power consumption for a candidate or proposed communication flow, and/or another type of power consumption associated with the modem 415, among other examples.

An overall estimated power consumption may include a metric that represents the power consumption of the modem 415 and of the various peripheral components of the UE 120, such as an RF front end of the UE 120. In some aspects, the modem 415 may determine the overall estimated power consumption periodically, based at least in part on a period parameter (denoted herein by T__{calc}) provided by the application processor 410 via the API 430. In some aspects, T__{calc} may include a time unit such as seconds, milliseconds, microseconds, and/or another time unit. A parameter T__{calc_slots} may indicate the quantity of slots that cover a period T__{calc}.

In some aspects, the modem 415 may determine the overall estimated power consumption of the modem 415 from the modem activity during the last T__{calc_slots} slots at every T__{calc} time unit. In other words, at every T__{calc} time unit, the modem 415 may determine the overall estimated power consumption of the modem 415 from the modem activity during non-overlapping windows of T__{calc_slots} slots. In some aspects, the modem 415 may determine the overall estimated power consumption of the modem 415 from the modem activity in each of the last T__{calc_slots} slots. In other words, the modem 415 may using a sliding window approach to determining the overall estimated power consumption, where the overall estimated power consumption is determined for overlapping groups of T__{calc_slots} slots.

The modem activity in a slot may represent the actions and/or operations performed by the modem 415 in the slot. The modem activity may be based at least in part on a duplexing scheme of the UE 120 (e.g., time division duplexing (TDD), frequency division duplexing (FDD)), a power saving feature or configuration of the modem 415, and/or another parameter.

The duplexing scheme that is used in a slot may dictate the slot format types that are used by the UE 120 in the slot. The slot format(s) that are used in a slot may represent the type(s) of activities performed by the UE 120 on the air interface in the slot between the UE 120 and the wireless network 100. For a TDD configuration in a slot, examples of slot format configurations that may be used in the slot include physical downlink control channel (PDCCH) only (e.g., no physical downlink shared channel (PDSCH) resources are used in the slot), PDCCH and PDSCH, physical uplink control channel (PUCCH) only (e.g., no physical uplink shared channel (PUSCH) resources are used in the slot), PUSCH only (e.g., no PUCCH resources are used in the slot), PUCCH and PUSCH, or no activity, among other examples. For an FDD configuration in a slot (e.g., which may include any combination of uplink and downlink slot formats), examples of downlink slot format configurations include PDCCH only (e.g., no PDSCH resources are used in the slot) or PDCCH and PDSCH, and examples of uplink slot format configurations include PUCCH only (e.g., no PUSCH resources are used in the slot), PUSCH only (e.g., no PUCCH resources are used in the slot), PUCCH and PUSCH, or no activity, among other examples.

In TDD, no activity may correspond to slots that are configured as uplink slots where neither PUCCH nor PUSCH are transmitted. In FDD, no activity may correspond to any slot where neither PUCCH nor PUSCH are transmitted. Note that only the channels whose reception or transmission depends on the data delivered by the application may be included in the slot formats described above. Transmission and/or reception of synchronization signal blocks (SSBs), channel state information reference signals (CSI-RSs), tracking reference signals (TRSs), sounding reference signals (SRSs), and/or other types of reference signals do not depend on the application.

Each slot format configuration described above consumes a specific power. The power that is consumed based at least in part on each slot format configuration may be contributed by the modem 415 (e.g., the baseband of the UE 120), an RF front end of the UE 120, an RF transceiver of the UE 120, and/or a power management integrated circuit (PMIC) of the UE 120, among other examples. The modem 415 may maintain a database that includes, for each slot format configuration described above, information identifying a power number associated with one or more of the components listed above. The database (or another type of data structure stored by the UE 120) may also include power numbers for different power saving configurations of the modem 415. For example, the database may include a first set of power numbers that are to be used for power consumption contribution calculations when the modem 415 is not operating in a power saving configuration, a second set of power numbers that are to be used for power consumption contribution calculations when the modem 415 is operating in a power saving configuration and in a high-power mode or in a high-throughput mode, a third set of power numbers that are to be used for power consumption contribution calculations when the modem 415 is operating in a power saving configuration and in a low-power mode, a third set of power numbers that are to be used for power consumption contribution calculations when the modem 415 is operating in a power saving configuration and is transitioning between modes, and so on.

Depending on the slot format configuration for a slot, the power number of one or more of the components may be 0, meaning that there is no contribution to the overall estimated power consumption from the component(s). For some components (e.g., an RF front end), the modem 415 maintains power numbers for each transmission power associated with the UE 120. Those numbers may be provided via a configuration file. The power numbers may be based at least in part on component carriers to which the slot format configurations apply. For example, the UE 120 may receive a PDCCH on several component carriers according to the slot format configuration.

For power saving configurations of the modem 415, one type of power saving configuration of the modem 415 may include a “no power saving feature” configuration in which the UE 120 is always in a single state, irrespective of whether the UE 120 is currently receiving or transmitting data. Another type of power saving configuration of the modem 415 may include a “power-saving feature with two states” configuration in which the UE 120 is configured such that the UE 120 can selectively be in one of two modes: a “high-throughput” mode or a “low-power” mode. The high-throughput mode may be used for the transmission of data with strong requirements, such as high throughput or low latency. The low-power mode may be used when the UE 120 has no ongoing data transmission or when the data being transmitted by the UE 120 has weaker requirements relative to the requirements of the data transmitted in the high-throughput mode. Examples of power saving features that may be included in a power saving configuration include discontinuous reception (DRX), connected mode DRX (CDRX), extended CDRX (E-CDRX), bandwidth part (BWP) switching, and/or search space set group (SSSG) switching, among other examples.

To determine the overall estimated power consumption when the power saving configuration of the modem 415 is a “no power saving feature” configuration as described above, the modem 415 may determine the quantity of slots with each slot format configuration described above during the last T__{calc_slots} slots, may determine the percentage/residency of each slot format configuration, may determine the power consumption contribution of each slot format configuration as the product of the percentage/residency of each slot format and the power consumption of each slot format configuration, and may sum all of the power consumption contributions. The sum of all of the power consumption contributions may correspond to the overall estimated power consumption.

For a TDD configuration, the modem 415 may determine the quantity of slots with slot format configuration PDCCH only (Num_pdcchOnly), the quantity of slots with slot format configuration PDCCH and PDSCH (Num_pdcchPdsch), the quantity of slots with slot format configuration PUCCH only (Num_pucch), the quantity of slots with slot format configuration PUSCH (Num_pusch), the quantity of slots with slot format configuration PUCCH and PUSCH (Num_pucchAndPusch), and the quantity of slots with slot format configuration no activity (Num_uNoActivity). The modem 415 may determine respective percentages of slots in the last T__{calc_slots} slots for each of these slot format configurations, which may correspond to the residences for each of these slot format configurations. For example, the residency for slot format configuration PDCCH only may correspond to respdcchOnly=(Num_pdcchOnly/T__{calc_slots}). The residencies for the remaining slot format configurations may be determined in a similar manner. The modem 415 may determine respective power consumption contributions for each of these slot format configurations as a product of their residency and power consumption of their specific slot configuration formats. The power consumption of a specific slot format configuration may be determined based at least in part on the power numbers in the database described above for the components described above. The modem 415 may use a set of power numbers in the database that are to be used for power consumption contribution calculations when the modem 415 is not operating in a power saving configuration. The power consumptions may also depend on the component carriers for each of the slot format configurations. The modem may sum all of the respective power consumption contributions for each of these slot format configurations to determine the overall estimated power consumption.

For an FDD configuration, the modem 415 may determine the overall estimated power consumption in a similar manner as described above for the TDD configuration, except the modem 415 uses the slot format configurations for FDD instead of TDD (e.g., Num_pdcchOnly, Num_pdcchOnlyAndPucch, Num_pdcchOnlyAndPusch).

To determine the overall estimated power consumption when the power saving configuration of the modem 415 is a “power-saving feature with two states” configuration as described above, the modem 415 may determine respective periods during the last T__{calc_slots} slots for which the UE 120 was in a high-throughput mode or a high-power mode, or was transitioning between these modes. For the high-throughput mode periods, the modem 415 may determine the quantity of slots, the residencies, and the respective power consumption contributions of each slot format configuration in the last T__{calc_slots} slots in a similar manner as described above for the “no power saving feature” configuration. However, the modem 415 may instead use a set of power numbers in the database that are to be used for power consumption contribution calculations when the modem 415 is operating in a power saving configuration and in a high-power mode or in a high-throughput mode for determining the respective power consumption contributions.

The modem 415 may also determine respective periods during the last T__{calc_slots} slots for which the UE 120 was in a low-power mode. For the low-power mode periods in the last T__{calc_slots} slots, the modem 415 determines the quantity of slots and associated residencies for each slot format configuration in the last T__{calc_slots} slots in a similar manner as described above for the “no power saving feature” configuration. The modem 415 may determine respective power consumption contributions of each slot format configuration in the last T__{calc_slots} slots for the low-power mode periods in a similar manner as described above for the “no power saving feature” configuration. However, the modem 415 may instead use a set of power numbers in the database that are to be used for power consumption contribution calculations when the modem 415 is operating in a power saving configuration and in a low-power mode for determining the respective power consumption contributions.

Moreover, for the low-power mode periods, the modem 415 may determine the quantity of slots, in the last T__{calc_slots} slots, for which the UE 120 was able to enter a sleep mode and the associated sleep mode type for each of the slots. The sleep mode type of a slot may be based at least in part on a depth of sleep of the UE 120 in the slot.

The depth of sleep represents the amount of power that is consumed during sleep. The deeper the sleep is, the less power is consumed. As an example, in a high-throughput mode, the modem 415 may consume “X” mW in a PDCCH slot. A slot with micro sleep (e.g., a Sleep Mode 1) may consume X1<X. A slot with light sleep (e.g., a Sleep Mode 2) may consume X2<X1<X. A slot with deep sleep (e.g., a Sleep Mode 3) may consume X3<X2<X1<X. Among the available depths of sleep, the UE 120 may select the corresponding sleep mode that fits best the number of slots while the UE 120 can sleep. Generally, the larger the gap is, the deeper the UE 120 can go to sleep. The modem 415 may determine the respective power saving power consumption contributions based at least in part on the quantity of slots, in the last T__{calc_slots} slots, for which the UE 120 was able to enter a sleep mode and the associated sleep mode type for each of the slots.

The modem 415 may also determine the periods during the last T__{calc_slots} slots for which the UE 120 was transitioning between modes when in the “power-saving feature with two states” configuration. For the transition periods, the modem 415 may determine the quantity of slots, the residencies, and the respective power consumption contributions of each slot format configuration in the last T__{calc_slots} slots in a similar manner as described above for the “no power saving feature” configuration. However, the modem 415 may instead use a set of power numbers in the database that are to be used for power consumption contribution calculations when the modem 415 is operating in a power saving configuration and is transitioning between modes for determining the respective power consumption contributions.

The modem 415 may sum all of the respective power consumption contributions for the high-throughput mode, the high-power mode, the lower-power mode, and the transition periods to determine the overall estimated power consumption for the last T__{calc_slots} slots in which the modem 415 is the “power-saving feature with two states” configuration.

A per-flow estimated power consumption may include a metric that represents the contribution of a specific communication flow (or a specific logical channel), associated with an application, to the overall estimated power consumption of the modem 415. The specific communication flow may include a downlink communication flow 420 associated with an application that is executed by the application processor 410 or an uplink communication flow 425 associated with an application that is executed by the application processor 410. In some aspects, the modem 415 determines respective per-flow estimated power consumptions for a downlink communication flow 420 and an uplink communication flow 425 associated with an application that is executed by the application processor 410. In some aspects, the modem 415 determines respective per-flow estimated power consumptions for communication flows associated with a plurality of applications.

When the power saving configuration of the modem 415 is a “no power saving feature” configuration as described above, the modem 415 may determine a per-flow estimated power consumption in a similar manner as described above for an overall estimated power consumption when in the “no power saving feature” configuration, except that the modem 415 considers only the contributions of a specific communication flow to the quantity of slots for each slot format configuration, the percentage/residency of each slot format configuration, and the power consumption contribution of each slot format configuration.

For a communication flow of index j, the modem 415 determines the quantity of slots for each slot format configuration in the last T__{calc_slots} slots by taking into account only the slots that carry information from the communication flow j. Slots with no activity are not considered in the per-flow estimated power consumption estimation. For a PDCCH only slot format configuration in TDD, the modem 415 may determine Num_pdcch_j, which is the quantity of slots with PDCCH that schedule PDSCH/PUSCH with data from communication flow j. For a PDCCH and PDSCH slot format configuration in TDD, the modem 415 may determine Num_pdcchPdsch_j, which is the quantity of slots with PDSCH carrying data from communication flow j. For a PUCCH only slot format configuration in TDD, the modem 415 may determine Num_pucch_j, which is the quantity of slots with PUCCH carrying hybrid automatic repeat request acknowledgement (HARQ-ACK) of PDSCH with data from communication flow j. For a PUSCH only slot format configuration in TDD, the modem 415 may determine Num_pusch_j, which is the quantity of slots with PUSCH carrying data from communication flow j. For a PUSCH only slot format configuration in TDD, the modem 415 may determine Num_pucchAndPusch_j, which is the quantity of slots with PUSCH with data from communication flow j and PUCCH with HARQ-ACK of PDSCH with communication flow j.

When the power saving configuration of the modem 415 is a “power-saving feature with two states” configuration as described above, the modem 415 may determine a per-flow estimated power consumption in a similar manner as described above for an overall estimated power consumption when in the “power-saving feature with two states” configuration. However, for the per-flow estimated power consumption, the modem 415 considers only the contributions of a specific communication flow to the quantity of slots for each slot format configuration, the percentage/residency of each slot format configuration, and the power consumption contribution of each slot format configuration for high-throughput mode periods and high-power mode periods. Moreover, low-power mode periods and transition periods are not included in the determination of the per-flow estimated power consumption, as these periods may not be considered to be flow specific.

A predicted power consumption may include a metric that represents an estimation of what the power consumption of the modem 415 would be with a specific traffic (which is a predicted traffic and is different from the traffic that is actually ongoing for a communication flow for an application that is executed by the application processor 410).

When the power saving configuration of the modem 415 is a “no power saving feature” configuration as described above, the modem 415 may determine a predicted power consumption in a similar manner as described above for an overall estimated power consumption when in the “no power saving feature” configuration, except that the modem 415 determines the predicted power consumption based at least in part on a candidate communication flow instead of the actual communication flows associated with the application processor 410. The candidate communication flow may be based on predicted traffic that is estimated or proposed by the application processor 410. From the predicted traffic, the modem 415 determines the predicted downlink throughput (Throughput_predicted_dl) and the predicted uplink throughput (Throughput_predicted_ul) over a proposed set of T__{calc_slots} slots. The modem 415 determines respective “measured” residencies for the last T__{calc_slots} slots for each slot format configuration in the last T__{calc_slots} slots, and determines respective predicted residencies for each slot format configuration in the proposed set of T__{calc_slots} slots by scaling the measured residencies (e.g., up or down) based at least in part on the predicted downlink throughput and/or the predicted uplink throughput. As an example, for the predicted residency of a PDCCH and PDSCH slot format configuration, the modem 415 may determine Res_pdcchPdsch_predicted=Res_pdcchPdsch_measured*(Throughput_predicted_dl/Throughput_measured_dl). The modem 415 may determine the remaining predicted residencies in a similar manner.

When the power saving configuration of the modem 415 is a “power-saving feature with two states” configuration as described above, the modem 415 may determine a predicted power consumption in a similar manner as described above for an overall estimated power consumption when in the “power-saving feature with two states” configuration However, for the predicted power consumption, the modem 415 determines the predicted power consumption based at least in part on a candidate communication flow instead of the actual communication flows associated with the application processor 410, as described above for the predicted power consumption determination for the “no power saving feature” configuration.

As further shown in FIG. 5, at 510, the modem 415 may provide an indication of the estimated power consumption of the modem 415 to the application processor 410. The modem 415 may provide the indication of the estimated power consumption in a power consumption report. The modem 415 may provide the indication of the estimated power consumption to the application processor 410 via the API 430. As indicated above, the estimated power consumption may include an overall estimated power consumption of the modem 415, a per-flow estimated power consumption (e.g., a power consumption for a specific communication flow associated with an application), a predicted power consumption for a candidate or proposed communication flow, and/or another type of power consumption associated with the modem 415, among other examples.

The modem 415 may provide power consumption reports (and indications of estimated power consumption included therein) in a periodic manner, a semi-periodic manner, an aperiodic manner, and/or an event-triggered manner (e.g., based at least in part on the occurrence of an event). In some aspects, the modem 415 determines the reporting type for the power consumption reports. In some aspects, the application processor 410 determines the reporting type for the power consumption reports and provides an indication of the reporting type to the modem 415 via the API 430. In these aspects, the modem 415 may provide power consumption reports (and indications of estimated power consumption included therein) in a periodic manner, a semi-periodic manner, an aperiodic manner, and/or an event-triggered manner based at least in part on the indication of the reporting type.

For periodic, semi-periodic, and event-trigger reporting, a period ‘T_ᵣₑₚₒᵣₜ’ may be provided by the application processor 410 to the modem 415 via the API 430. The period may be indicated as a time unit (e.g., in milliseconds or another time unit).

For event-triggered reporting, the application processor 410 may provide one or more event-triggering parameters to the modem 415 via the API 430. In some aspects, the event-triggering parameters include a ‘Thresh__{powerConsumption_report}’ parameter, which may include a threshold that the estimated power consumption is compared with. Here, the modem 415 may provide the indication of the estimated power consumption based at least in part on determining that the magnitude of the estimated power consumption satisfies the ‘Thresh__{powerConsumption_report}’ threshold.

In some aspects, the event-triggering parameters include a ‘Thresh__{txPower_report}’ parameter, which may include a threshold that the averaged transmit power of the UE 120 is compared with. Here, the modem 415 may provide the indication of the estimated power consumption based at least in part on determining that the magnitude of the average transmit power of the UE 120 satisfies the ‘Thresh__{txPower_report}’ threshold.

In some aspects, the event-triggering parameters include a ‘Condition report’ parameter, which may include one or more conditions that the modem 415 considers for reporting. Here, the modem 415 may provide the indication of the estimated power consumption based at least in part on determining that at least one of the condition(s) is satisfied. Examples of conditions include power consumption, transmit power, at least one of power consumption OR transmit power, or both power consumption AND transmit power.

For example, the modem 415 may provide the indication of the estimated power consumption based at least in part on determining that estimated power consumption is greater than or equal to the ‘Thresh__{powerConsumption_report}’ threshold. As another example, the modem 415 may provide the indication of the estimated power consumption based at least in part on determining that the average transmit power of the UE 120 is greater than or equal to the ‘Thresh__{txPower_report}’ threshold. As another example, the modem 415 may provide the indication of the estimated power consumption based at least in part on determining at least one of: the estimated power consumption is greater than or equal to the ‘Thresh__{powerConsumption_report}’ threshold or the average transmit power of the UE 120 is greater than or equal to the ‘Thresh__{txPower_report}’ threshold. As another example, the modem 415 may provide the indication of the estimated power consumption based at least in part on determining that both of: the estimated power consumption is greater than or equal to the ‘Thresh__{powerConsumption_report}’ threshold and the average transmit power of the UE 120 is greater than or equal to the ‘Thresh__{txpower_report}’ threshold.

In some aspects, the event-triggering parameters include a combination of the above-described parameters. In these aspects, the UE 120 may provide the indication of the estimated power consumption based at least in part on determining that one or more of the event-triggering parameters are satisfied. In some aspects, the modem 415 continues to provide periodic indications of estimated power consumptions every reporting period T_ᵣₑₚₒᵣₜ′ when the one or more of the event-triggering parameters are satisfied, and stops providing indications of estimated power consumptions based at least in part on determining that the one or more of the event-triggering parameters are no longer satisfied.

For periodic reporting, the application processor 410 may provide (e.g., via the API 430) a periodic reporting configuration to the modem 415. The periodic reporting configuration may indicate a reporting period T_ᵣₑₚₒᵣₜ′ for providing periodic indications of the estimated power consumption of the modem 415. The modem 415 may report an estimated power consumption to the application processor 410 as soon as a power consumption report is generated and is available after the reception of a periodic reporting configuration. The modem 415 may continue to provide periodic power consumption reports (e.g., that include periodic indications of the estimated power consumption of the modem 415) every T_ᵣₑₚₒᵣₜ′ reporting period.

For semi-periodic reporting, the application processor 410 may provide (e.g., via the API 430) a reporting request that activates semi-periodic reporting for the estimated power consumption of the modem 415. The modem 415 may report an estimated power consumption to the application processor 410 as soon as a power consumption report is generated and is available after the reception of a reporting request from the application processor 410 that activates the semi-periodic reporting. The modem 415 may continue to provide periodic power consumption reports (e.g., that include periodic indications of the estimated power consumption of the modem 415) every ‘T_ᵣₑₚₒᵣₜ’ until the application processor 410 provides (e.g., via the API 430) a reporting cancel request to the modem 415.

For aperiodic reporting, the application processor 410 may provide (e.g., via the API 430) a reporting request that activates aperiodic reporting for the estimated power consumption of the modem 415. The modem 415 may report an estimated power consumption to the application processor 410 as soon as a power consumption report is generated and is available after the reception of a reporting request from the application processor 410 that activates the aperiodic reporting. However, unlike the semi-periodic reporting described above, the estimated power consumption is a “one-shot” power consumption report in that the modem 415 does not provide additional indications of additional estimated power consumptions until another reporting request is received from the application processor 410 via the API 430.

The format of the indication of the estimated power consumption (and/or the power consumption report that includes the indication of the estimated power consumption) may be an absolute or explicit indication of the estimated power consumption and/or a relative or implicit indication of the estimated power consumption. An absolute or explicit indication of the estimated power consumption may be an indication of the actual estimated power consumption as a unit of power (e.g., milliwatts (mW)). For these types of reports, each modem activity, as used in the estimated power consumption determination, may be assigned an absolute value in the unit of power, which may be modem specific.

A relative or implicit indication of the estimated power consumption may be an indication of the estimated power consumption in relative units. In other words, the estimated power consumption may be indicated relative to a set value in a unit of power. For example, if the estimated power consumption is 300 mW, and the set value is 250 mW, the estimated power consumption may be indicated implicitly relative to the 250 mW set value as 50 mW. The units of power and/or the set value may be defined in a wireless communication standard, such as 3GPP TR 38.840 in tables 18 to 21, or any implementation specific unit. For these types of reports, each modem activity, as used in the estimated power consumption determination, may be assigned a relative value.

In some cases, the estimated power consumption of the modem 415 may be highly dependent on the pathloss between the UE 120 and the application server 405 (and/or between the UE 120 and the wireless network 100) and/or on the transmit power of the UE 120. Accordingly, in addition to the estimated power consumption, the modem 415 may also provide an indication of the pathloss and/or the transmit power to the application processor 410 via the API 430. The reported pathloss and/or the reported transmit power may include averages that are determined over the last period ‘T__{calc}’.

As indicated above, the modem 415 may determine a per-flow estimated power consumption, which may include an estimated power consumption for a specific communication flow (or a specific logical channel) associated with an application. The per-flow estimated power consumption may represent the contribution of a specific communication flow (or a specific logical channel) to the overall estimated power consumption of the modem 415. A per-flow estimated power consumption may be indicated as a percentage of the overall estimated power consumption, as a ratio of the per-flow estimated power consumption to the overall estimated power consumption, or indicated in another suitable manner.

The per-flow estimated power consumption may be used by application processor 410 for decisions regarding the techniques that are used to reduce the power consumption of the modem 415. As an example, if the overall estimated power consumption is too large, the application processor 410 may reduce the throughput of the communication flows of an associated application that contributes the most to the overall estimated power consumption of the modem 415.

The per-flow estimated power consumption determination and reporting may be controlled by the application processor 410. For example, the application processor 410 may provide a per-flow reporting configuration to the modem 415 via the API 430. The per-flow reporting configuration may indicate the communication flows for which the modem 415 is to determine and report per-flow estimated power consumptions, the reporting types (e.g., periodic, aperiodic, semi-periodic, event-triggered) for the communication flows, and/or another parameter for the communication flows. In some aspects, the modem 415 may report the per-flow estimated power consumption(s) to the application processor 410 via the API 430 in addition to and/or alternatively to the overall estimated power consumption of the modem 415.

As indicated above, the modem 415 may determine a predicted power consumption, which may include a power consumption that is determined for a candidate or proposed communication flow associated with an application (e.g., a communication flow that is not currently in use by the application, and may or may not be used in the future by the application). In other words, a predicted power consumption represents a prediction of what the power consumption of the modem 415 would be with a specific traffic configuration (e.g., if the throughput of a communication flow was divided by 2).

The predicted power consumption for a candidate communication flow may be used by the application processor 410 for decisions regarding the techniques that the application processor 410 can use to reduce the power consumption of the modem 415 for an application. As an example, if the overall estimated power consumption of the modem 415 is too large, the application processor 410 may use predicted power consumptions to determine the types of modifications that can be made to a communication flow to reduce the power consumption of the modem 415 without actually having to first change communication flow. In this way, the application processor 410 may estimate or predict the power savings for a given set of communication flow modifications if the throughput were reduced and/or one or more other parameters were changed for the communication flow.

For a predicted power consumption of the modem 415, the modem 415 may determine the predicted power consumption in a similar manner as described above, except that instead of using the actual traffic and associated parameters for a communication flow, a ‘specific’ traffic is used for the determination of residencies and other power consumption parameters for the communication flow. At any time, the application processor 410 may configure a list of specific traffics (and may provide the list to the modem 415 via the API 430) to be used for determining a predicted power consumption. Whenever the modem 415 reports an overall estimated power consumption, the modem 415 may also include a list of predicted power consumptions that were determined from the latest list of specific traffics, as configured by the application processor 410.

In this way, the modem 415 may determine an estimated power consumption of the modem 415, may generate a power consumption report that indicates the estimated power consumption, and may report the power consumption report to the application processor 410 via the API 430.

In some aspects, the modem 415 may calculate the estimated power consumption periodically, from a period ‘T__{calc}’ (in time unit) provided by the application processor 410. In some aspects, the modem 415 may calculate the power consumption from the modem activity in two different ways: (1) every ‘T__{calc}’, the modem 415 may track the activity of the modem 415 during the last ‘T__{calc_slots}’ slots (e.g., non-overlapping windows), and (2) at each time unit, the modem 415 may track the activity of the modem 415 during the last ‘T__{calc_slots}’ slots (e.g., sliding windows). In some aspects, the modem 415 may maintain a database of power numbers for all contributors to the estimated power consumption of the modem 415. In some aspects, the estimated power consumption that is determined by the modem 415 may include the sum of the estimated power consumption contributions of all modem activities during the last ‘T__{calc_slots}’ slots. In some aspects, the estimated power consumption contribution of each modem activity may include the product of the residency of the activity and of the power consumption of that activity. In some aspects, the modem 415 may calculate an ‘overall’, a ‘per-flow,’ and/or a ‘predicted’ power consumption of the modem 415.

In some aspects, the modem 415 may report the estimated power consumption in a periodic, semi-periodic, aperiodic or event-triggered manner. In some aspects, the application processor 410 provides (e.g., via the API 430) the modem 415 with the period ‘T_ᵣₑₚₒᵣₜ’ to be used for periodic, semi-periodic and event-triggered reporting. In some aspects, the application processor 410 provides the modem 415 with the conditions for reporting and with the thresholds ‘Thresh__{powerConsumption_report}’ and ‘Thresh__{txPower_report}’ to be used for event-triggered reporting.

In some aspects, the overall estimated power consumption may be either in absolute format (e.g., mW) or in a relative format. In some aspects, in addition to the overall estimated power consumption, the modem 415 can also report the pathloss and transmit power of the UE 120. In some aspects, the modem 415 can report the ‘per-flow’ estimated power consumption, which may include an indication of the contribution of a communication flow to the overall estimated power consumption. This ‘per-flow’ estimated power consumption (or the parameters thereof) may be controlled by the application processor 410. In some aspects, the modem 415 can report a list of ‘predicted’ power consumptions, each of those being a prediction of what the power consumption of the modem 415 would be with a specific traffic. This ‘predicted’ power consumption report, as well as the list of specific traffics to be used for the predictions, may be controlled and/or indicated by the application processor 410.

As indicated above, FIG. 5 is provided as an example. Other examples may differ from what is described with regard to FIG. 5.

FIG. 6 is a diagram illustrating an example process 600 performed, for example, by a UE, in accordance with the present disclosure. Example process 600 is an example where the UE (e.g., UE 120) performs operations associated with power consumption calculation and reporting.

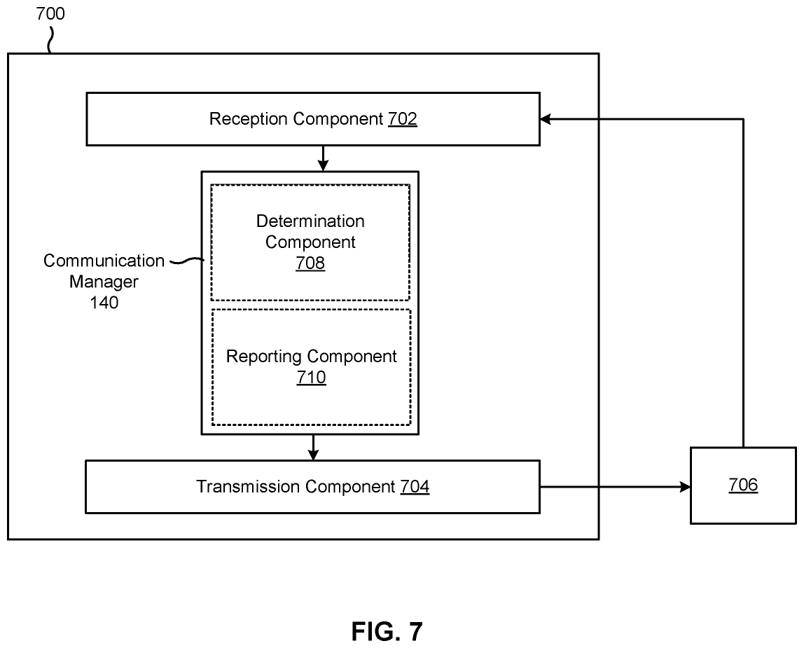

As shown in FIG. 6, in some aspects, process 600 may include determining, using a modem of the UE, an estimated power consumption of the modem (block 610). For example, the UE (e.g., using communication manager 140 and/or determination component 708, depicted in FIG. 7) may determine, using a modem of the UE, an estimated power consumption of the modem, as described above.

As further shown in FIG. 6, in some aspects, process 600 may include providing, using the modem, an indication of the estimated power consumption to an application processor of the UE (block 620). For example, the UE (e.g., using communication manager 140 and/or reporting component 710, depicted in FIG. 7) may provide, using the modem, an indication of the estimated power consumption to an application processor of the UE, as described above.

Process 600 may include additional aspects, such as any single aspect or any combination of aspects described below and/or in connection with one or more other processes described elsewhere herein.

In a first aspect, providing the indication of the estimated power consumption comprises providing the indication of the estimated power consumption to the application processor through an API between the modem and the application processor.

In a second aspect, alone or in combination with the first aspect, determining the estimated power consumption comprises determining at least one of an overall estimated power consumption of the modem, an estimated per-flow power consumption of the modem for a communication flow associated with a particular application associated with the application processor, or a predicted power consumption of the modem for a candidate communication flow.

In a third aspect, alone or in combination with one or more of the first and second aspects, determining the estimated power consumption comprises periodically determining the estimated power consumption based at least in part on a time period parameter.

In a fourth aspect, alone or in combination with one or more of the first through third aspects, periodically determining the estimated power consumption comprises determining the estimated power consumption across a plurality of consecutive slots that span a time period indicated by the time period parameter.

In a fifth aspect, alone or in combination with one or more of the first through fourth aspects, periodically determining the estimated power consumption comprises determining the estimated power consumption in each of a plurality of consecutive slots that span a time period indicated by the time period parameter.

In a sixth aspect, alone or in combination with one or more of the first through fifth aspects, determining the estimated power consumption comprises determining the estimated power consumption based at least in part on one or more power consumption parameters associated with the UE, wherein the one or more power consumption parameters include at least one of a duplexing configuration for the UE, a power saving configuration for the UE, or one or more slot format types configured for the UE.

In a seventh aspect, alone or in combination with one or more of the first through sixth aspects, determining the estimated power consumption based at least in part on the one or more power consumption parameters comprises identifying respective power consumption values for each component of the modem based at least in part on the one or more power consumption parameters, and determining the estimated power consumption based at least in part on the respective power consumption values.

In an eighth aspect, alone or in combination with one or more of the first through seventh aspects, identifying the respective power consumption values for each component of the modem comprises identifying the respective power consumption values in a data structure stored by the UE.

In a ninth aspect, alone or in combination with one or more of the first through eighth aspects, determining the estimated power consumption comprises determining the estimated power consumption for a time period that includes a plurality of slots, wherein determining the estimated power consumption for the time period comprises determining a respective percentage of slots occupied by each slot format that is used in the plurality of slots, determining respective power values for each slot format that is used in the plurality of slots, determining respective power consumption contributions for each slot format that is used in the plurality of slots based at least in part on the respective percentages and the respective power values, and determining the estimated power consumption for the time period based at least in part on the respective power consumption contributions.

In a tenth aspect, alone or in combination with one or more of the first through ninth aspects, determining the respective percentage of slots occupied by each slot format that is used in the plurality of slots comprises determining first respective percentages of slots in which the UE operates in a high throughput mode, and that are occupied by each slot format that is used in the plurality of slots, determining second respective percentages of slots in which the UE operates in a power saving mode, and that are occupied by each slot format that is used in the plurality of slots, and determining third respective percentages of slots in which the UE operates in a transition mode between the high throughput mode and the power saving mode.

In an eleventh aspect, alone or in combination with one or more of the first through tenth aspects, determining the respective power values for each slot format that is used in the plurality of slots comprises determining first respective power values, associated with the high throughput mode, for each slot format that is used in the plurality of slots, determining second respective power values, associated with the power saving mode, for each slot format that is used in the plurality of slots, and determining third respective power values associated with the transition mode.

In a twelfth aspect, alone or in combination with one or more of the first through eleventh aspects, determining the respective power consumption contributions for each slot format that is used in the plurality of slots comprises determining respective high throughput power consumption contributions for each slot format that is used in the plurality of slots based at least in part on the first respective percentages and the first respective power values, determining respective power saving power consumption contributions for each slot format that is used in the plurality of slots based at least in part on the second respective percentages and the second respective power values, and determining respective transition mode power consumption contributions based at least in part on the third respective percentages and the third respective power values.

In a thirteenth aspect, alone or in combination with one or more of the first through twelfth aspects, determining the respective power saving power consumption contributions comprises determining the respective power saving power consumption contributions based at least in part on a type of sleep mode that is used in the plurality of slots by the UE.

In a fourteenth aspect, alone or in combination with one or more of the first through thirteenth aspects, determining the estimated power consumption for the time period comprises determining the estimated power consumption based at least in part on the respective high throughput power consumption contributions, the respective power saving power consumption contributions, and the respective transition mode power consumption contributions.

In a fifteenth aspect, alone or in combination with one or more of the first through fourteenth aspects, determining the respective percentages of slots occupied by each slot format that is used in the plurality of slots comprises determining, for a communication flow associated with an application that is executed by the application processor, the respective percentages of slots occupied by each slot format that is used in the plurality of slots, wherein determining the respective power values for each slot format that is used in the plurality of slots comprises determining, for the communication flow, the respective power values for each slot format that is used in the plurality of slots, wherein determining the respective power consumption contributions for each slot format that is used in the plurality of slots comprises determining, for the communication flow, the respective power consumption contributions for each slot format that is used in the plurality of slots, and wherein determining the estimated power consumption comprises determining, for the communication flow, the estimated power consumption.

In a sixteenth aspect, alone or in combination with one or more of the first through fifteenth aspects, determining the respective percentages of slots occupied by each slot format that is used in the plurality of slots for the communication flow comprises determining a quantity of PDCCH only slots in the plurality of slots, determining a quantity of PDCCH and PDSCH slots in the plurality of slots, determining a quantity of PUCCH only slots in the plurality of slots, determining a quantity of PUSCH only slots in the plurality of slots, determining a quantity of PUCCH and PUSCH slots in the plurality of slots, and determining the respective percentages based at least in part on the quantity of PDSCH only slots, the quantity of PDCCH and PDSCH slots, the quantity of PUCCH only slots, the quantity of PUSCH only slots, and the quantity of PUCCH and PUSCH slots.

In a seventeenth aspect, alone or in combination with one or more of the first through sixteenth aspects, process 600 includes determining, for a candidate communication flow associated with an application that is executed by the application processor, respective predicted throughputs in another plurality of slots, determining, for the candidate communication flow, respective predicted percentages of slots occupied by each slot format that is used in the other plurality of slots, wherein the respective predicted percentages are based at least in part on the respective percentages and the respective predicted throughputs, determining, for the candidate communication flow, respective predicted power values for each slot format that is used in the other plurality of slots, determining, for the candidate communication flow, respective predicted power consumption contributions for each slot format that is used in the other plurality of slots, wherein the respective predicted power consumption contributions are based at least in part on the respective predicted percentages and the respective predicted power values, and determining, for the candidate communication flow, a predicted power consumption based at least in part on the respective predicted power consumption contributions.

In an eighteenth aspect, alone or in combination with one or more of the first through seventeenth aspects, the predicted power consumption is based at least in part on a power saving mode of the UE.

In a nineteenth aspect, alone or in combination with one or more of the first through eighteenth aspects, providing the indication of the estimated power consumption to the application processor of the UE comprises at least one of providing a periodic estimated power consumption report to the application processor of the UE, providing a semi-periodic estimated power consumption report to the application processor of the UE, providing an aperiodic estimated power consumption report to the application processor of the UE, or providing event-triggered estimated power consumption reports to the application processor of the UE.

In a twentieth aspect, alone or in combination with one or more of the first through nineteenth aspects, process 600 includes receiving, at the modem and from the application processor, a periodicity for providing estimated power consumption reports, and providing the indication of the estimated power consumption to the application processor of the UE comprises providing the estimated power consumption reports to the application processor of the UE based at least in part on the periodicity.

In a twenty-first aspect, alone or in combination with one or more of the first through twentieth aspects, providing the indication of the estimated power consumption to the application processor of the UE comprises at least one of providing the indication of the estimated power consumption to the application processor based at least in part on determining that a power consumption parameter satisfies a threshold, or providing the indication of the estimated power consumption to the application processor based at least in part on determining that a power consumption reporting condition is satisfied.

In a twenty-second aspect, alone or in combination with one or more of the first through twenty-first aspects, the indication of the estimated power consumption comprises an explicit indication of an estimated power consumption value.

In a twenty-third aspect, alone or in combination with one or more of the first through twenty-second aspects, the indication of the estimated power consumption comprises an indication of an estimated power consumption value relative to a standardized power consumption value.

In a twenty-fourth aspect, alone or in combination with one or more of the first through twenty-third aspects, process 600 includes providing, from the modem to the application processor, an indication of at least one of an estimated pathloss between the UE and a network node, or an estimated transmit power for the UE.

In a twenty-fifth aspect, alone or in combination with one or more of the first through twenty-fourth aspects, the indication of the estimated power consumption comprises an indication of an overall estimated power consumption of the modem, and an indication of a plurality of estimated per-flow power consumptions of the modem for an associated plurality of communication flows associated with the application processor, wherein each of the plurality of estimated per-flow power consumptions is indicated as a percentage of the overall estimated power consumption of the modem.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram of an example apparatus 700 for wireless communication. The apparatus 700 may be a UE (e.g., a UE 120), or a UE may include the apparatus 700. In some aspects, the apparatus 700 includes a reception component 702 and a transmission component 704, which may be in communication with one another (for example, via one or more buses and/or one or more other components). As shown, the apparatus 700 may communicate with another apparatus 706 (such as a UE, a network node, or another wireless communication device) using the reception component 702 and the transmission component 704. As further shown, the apparatus 700 may include the communication manager 140. The communication manager 140 may include one or more of a determination component 708 or a reporting component 710, among other examples.

In some aspects, the apparatus 700 may be configured to perform one or more operations described herein in connection with FIGS. 4 and/or 5. Additionally, or alternatively, the apparatus 700 may be configured to perform one or more processes described herein, such as process 600 of FIG. 6. In some aspects, the apparatus 700 and/or one or more components shown in FIG. 7 may include one or more components of the UE described in connection with FIG. 2. Additionally, or alternatively, one or more components shown in FIG. 7 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 702 may receive communications, such as reference signals, control information, data communications, or a combination thereof, from the apparatus 706. The reception component 702 may provide received communications to one or more other components of the apparatus 700. In some aspects, the reception component 702 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 700. In some aspects, the reception component 702 may include one or more antennas, a modem, a demodulator, a MIMO detector, a receive processor, a controller/processor, a memory, or a combination thereof, of the UE described in connection with FIG. 2.

The transmission component 704 may transmit communications, such as reference signals, control information, data communications, or a combination thereof, to the apparatus 706. In some aspects, one or more other components of the apparatus 700 may generate communications and may provide the generated communications to the transmission component 704 for transmission to the apparatus 706. In some aspects, the transmission component 704 may perform signal processing on the generated communications (such as filtering, amplification, modulation, digital-to-analog conversion, multiplexing, interleaving, mapping, or encoding, among other examples), and may transmit the processed signals to the apparatus 706. In some aspects, the transmission component 704 may include one or more antennas, a modem, a modulator, a transmit MIMO processor, a transmit processor, a controller/processor, a memory, or a combination thereof, of the UE described in connection with FIG. 2. In some aspects, the transmission component 704 may be co-located with the reception component 702 in a transceiver.

The determination component 708 may determine, using a modem of the UE, an estimated power consumption of the modem. The reporting component 710 may provide, using the modem, an indication of the estimated power consumption to an application processor of the apparatus 700.

The determination component 708 may determine, for a candidate communication flow associated with an application that is executed by the application processor, respective predicted throughputs in another plurality of slots.

The determination component 708 may determine, for the candidate communication flow, respective predicted percentages of slots occupied by each slot format that is used in the other plurality of slots, wherein the respective predicted percentages are based at least in part on the respective percentages and the respective predicted throughputs.

The determination component 708 may determine, for the candidate communication flow, respective predicted power values for each slot format that is used in the other plurality of slots.

The determination component 708 may determine, for the candidate communication flow, respective predicted power consumption contributions for each slot format that is used in the other plurality of slots, wherein the respective predicted power consumption contributions are based at least in part on the respective predicted percentages and the respective predicted power values.

The determination component 708 may determine, for the candidate communication flow, a predicted power consumption based at least in part on the respective predicted power consumption contributions.

The reception component 702 may receive, at the modem and from the application processor, a periodicity for providing estimated power consumption reports.

The reporting component 710 may provide, from the modem to the application processor, an indication of at least one of an estimated pathloss between the UE and a network node, or an estimated transmit power for the apparatus 700.

The number and arrangement of components shown in FIG. 7 are provided as an example. In practice, there may be additional components, fewer components, different components, or differently arranged components than those shown in FIG. 7. Furthermore, two or more components shown in FIG. 7 may be implemented within a single component, or a single component shown in FIG. 7 may be implemented as multiple, distributed components. Additionally, or alternatively, a set of (one or more) components shown in FIG. 7 may perform one or more functions described as being performed by another set of components shown in FIG. 7.

The following provides an overview of some Aspects of the present disclosure:

Aspect 1: A method of wireless communication performed by a user equipment (UE), comprising: determining, using a modem of the UE, an estimated power consumption of the modem; and providing, using the modem, an indication of the estimated power consumption to an application processor of the UE.

Aspect 2: The method of Aspect 1, wherein providing the indication of the estimated power consumption comprises: providing the indication of the estimated power consumption to the application processor through an application programming interface (API) between the modem and the application processor.

Aspect 3: The method of Aspect 1 or 2, wherein determining the estimated power consumption comprises determining at least one of: an overall estimated power consumption of the modem, an estimated per-flow power consumption of the modem for a communication flow associated with a particular application associated with the application processor, or a predicted power consumption of the modem for a candidate communication flow.

Aspect 4: The method of one or more of Aspects 1-3, wherein determining the estimated power consumption comprises: periodically determining the estimated power consumption based at least in part on a time period parameter.

Aspect 5: The method of Aspect 4, wherein periodically determining the estimated power consumption comprises: determining the estimated power consumption across a plurality of consecutive slots that span a time period indicated by the time period parameter.

Aspect 6: The method of Aspect 4 or 5, wherein periodically determining the estimated power consumption comprises: determining the estimated power consumption in each of a plurality of consecutive slots that span a time period indicated by the time period parameter.

Aspect 7: The method of one or more of Aspects 1-6, wherein determining the estimated power consumption comprises: determining the estimated power consumption based at least in part on one or more power consumption parameters associated with the UE, wherein the one or more power consumption parameters include at least one of: a duplexing configuration for the UE, a power saving configuration for the UE, or one or more slot format types configured for the UE.

Aspect 8: The method of Aspect 7, wherein determining the estimated power consumption based at least in part on the one or more power consumption parameters comprises: identifying respective power consumption values for each component of the modem based at least in part on the one or more power consumption parameters; and determining the estimated power consumption based at least in part on the respective power consumption values.

Aspect 9: The method of Aspect 8, wherein identifying the respective power consumption values for each component of the modem comprises: identifying the respective power consumption values in a data structure stored by the UE.

Aspect 10: The method of one or more of Aspects 1-9, wherein determining the estimated power consumption comprises: determining the estimated power consumption for a time period that includes a plurality of slots, wherein determining the estimated power consumption for the time period comprises: determining a respective percentage of slots occupied by each slot format that is used in the plurality of slots; determining respective power values for each slot format that is used in the plurality of slots; determining respective power consumption contributions for each slot format that is used in the plurality of slots based at least in part on the respective percentages and the respective power values; and determining the estimated power consumption for the time period based at least in part on the respective power consumption contributions.

Aspect 11: The method of Aspect 10, wherein determining the respective percentage of slots occupied by each slot format that is used in the plurality of slots comprises: determining first respective percentages of slots in which the UE operates in a high throughput mode, and that are occupied by each slot format that is used in the plurality of slots; determining second respective percentages of slots in which the UE operates in a power saving mode, and that are occupied by each slot format that is used in the plurality of slots; and determining third respective percentages of slots in which the UE operates in a transition mode between the high throughput mode and the power saving mode.

Aspect 12: The method of Aspect 11, wherein determining the respective power values for each slot format that is used in the plurality of slots comprises: determining first respective power values, associated with the high throughput mode, for each slot format that is used in the plurality of slots; determining second respective power values, associated with the power saving mode, for each slot format that is used in the plurality of slots; and determining third respective power values associated with the transition mode.

Aspect 13: The method of Aspect 12, wherein determining the respective power consumption contributions for each slot format that is used in the plurality of slots comprises: determining respective high throughput power consumption contributions for each slot format that is used in the plurality of slots based at least in part on the first respective percentages and the first respective power values; determining respective power saving power consumption contributions for each slot format that is used in the plurality of slots based at least in part on the second respective percentages and the second respective power values; and determining respective transition mode power consumption contributions based at least in part on the third respective percentages and the third respective power values.

Aspect 14: The method of Aspect 13, wherein determining the respective power saving power consumption contributions comprises: determining the respective power saving power consumption contributions based at least in part on a type of sleep mode that is used in the plurality of slots by the UE.

Aspect 15: The method of Aspect 13 or 14, wherein determining the estimated power consumption for the time period comprises: determining the estimated power consumption based at least in part on: the respective high throughput power consumption contributions, the respective power saving power consumption contributions, and the respective transition mode power consumption contributions.

Aspect 16: The method of one or more of Aspects 10-15, wherein determining the respective percentages of slots occupied by each slot format that is used in the plurality of slots comprises: determining, for a communication flow associated with an application that is executed by the application processor, the respective percentages of slots occupied by each slot format that is used in the plurality of slots; wherein determining the respective power values for each slot format that is used in the plurality of slots comprises: determining, for the communication flow, the respective power values for each slot format that is used in the plurality of slots; wherein determining the respective power consumption contributions for each slot format that is used in the plurality of slots comprises: determining, for the communication flow, the respective power consumption contributions for each slot format that is used in the plurality of slots; and wherein determining the estimated power consumption comprises: determining, for the communication flow, the estimated power consumption.

Aspect 17: The method of Aspect 16, wherein determining the respective percentages of slots occupied by each slot format that is used in the plurality of slots for the communication flow comprises: determining a quantity of physical downlink control channel (PDCCH) only slots in the plurality of slots; determining a quantity of PDCCH and physical downlink shared channel (PDSCH) slots in the plurality of slots; determining a quantity of physical uplink control channel (PUCCH) only slots in the plurality of slots; determining a quantity of physical uplink shared channel (PUSCH) only slots in the plurality of slots; determining a quantity of PUCCH and PUSCH slots in the plurality of slots; and determining the respective percentages based at least in part on the quantity of PDSCH only slots, the quantity of PDCCH and PDSCH slots, the quantity of PUCCH only slots, the quantity of PUSCH only slots, and the quantity of PUCCH and PUSCH slots.

Aspect 18: The method of one or more of Aspects 10-17, further comprising: determining, for a candidate communication flow associated with an application that is executed by the application processor, respective predicted throughputs in another plurality of slots; determining, for the candidate communication flow, respective predicted percentages of slots occupied by each slot format that is used in the other plurality of slots, wherein the respective predicted percentages are based at least in part on the respective percentages and the respective predicted throughputs; determining, for the candidate communication flow, respective predicted power values for each slot format that is used in the other plurality of slots; determining, for the candidate communication flow, respective predicted power consumption contributions for each slot format that is used in the other plurality of slots; wherein the respective predicted power consumption contributions are based at least in part on the respective predicted percentages and the respective predicted power values; and determining, for the candidate communication flow, a predicted power consumption based at least in part on the respective predicted power consumption contributions.

Aspect 19: The method of Aspect 18, wherein the predicted power consumption is based at least in part on a power saving mode of the UE.

Aspect 20: The method of one or more of Aspects 1-19, wherein providing the indication of the estimated power consumption to the application processor of the UE comprises at least one of: providing a periodic estimated power consumption report to the application processor of the UE, providing a semi-periodic estimated power consumption report to the application processor of the UE, providing an aperiodic estimated power consumption report to the application processor of the UE, or providing event-triggered estimated power consumption reports to the application processor of the UE.

Aspect 21: The method of one or more of Aspects 1-20, further comprising: receiving, at the modem and from the application processor, a periodicity for providing estimated power consumption reports; and wherein providing the indication of the estimated power consumption to the application processor of the UE comprises: providing the estimated power consumption reports to the application processor of the UE based at least in part on the periodicity. wherein providing the indication of the estimated power consumption to the application processor of the UE comprises: providing the estimated power consumption reports to the application processor of the UE based at least in part on the periodicity.

Aspect 22: The method of one or more of Aspects 1-21, wherein providing the indication of the estimated power consumption to the application processor of the UE comprises at least one of: providing the indication of the estimated power consumption to the application processor based at least in part on determining that a power consumption parameter satisfies a threshold; or providing the indication of the estimated power consumption to the application processor based at least in part on determining that a power consumption reporting condition is satisfied.

Aspect 23: The method of one or more of Aspects 1-22, wherein the indication of the estimated power consumption comprises an explicit indication of an estimated power consumption value.

Aspect 24: The method of one or more of Aspects 1-23, wherein the indication of the estimated power consumption comprises an indication of an estimated power consumption value relative to a standardized power consumption value.

Aspect 25: The method of one or more of Aspects 1-14, further comprising: providing, from the modem to the application processor, an indication of at least one of: an estimated pathloss between the UE and a network node, or an estimated transmit power for the UE.

Aspect 26: The method of one or more of Aspects 1-25, wherein the indication of the estimated power consumption comprises: an indication of an overall estimated power consumption of the modem, and an indication of a plurality of estimated per-flow power consumptions of the modem for an associated plurality of communication flows associated with the application processor, wherein each of the plurality of estimated per-flow power consumptions is indicated as a percentage of the overall estimated power consumption of the modem.

Aspect 27: An apparatus for wireless communication at a device, comprising a processor; memory coupled with the processor; and instructions stored in the memory and executable by the processor to cause the apparatus to perform the method of one or more of Aspects 1-26.

Aspect 28: A device for wireless communication, comprising a memory and one or more processors coupled to the memory, the one or more processors configured to perform the method of one or more of Aspects 1-26.

Aspect 29: An apparatus for wireless communication, comprising at least one means for performing the method of one or more of Aspects 1-26.

Aspect 30: A non-transitory computer-readable medium storing code for wireless communication, the code comprising instructions executable by a processor to perform the method of one or more of Aspects 1-26.

Aspect 31: A non-transitory computer-readable medium storing a set of instructions for wireless communication, the set of instructions comprising one or more instructions that, when executed by one or more processors of a device, cause the device to perform the method of one or more of Aspects 1-26.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
a memory; and
one or more processors, coupled to the memory, configured to:
determine, using a modem of the UE, an estimated power consumption of the modem; and
provide, using the modem, an indication of the estimated power consumption to an application processor of the UE.

2. The UE of claim 1, wherein the one or more processors, to provide the indication of the estimated power consumption, are configured to:
provide the indication of the estimated power consumption to the application processor through an application programming interface (API) between the modem and the application processor.

3. The UE of claim 1, wherein the one or more processors, to determine the estimated power consumption, are configured to determine at least one of:
an overall estimated power consumption of the modem,
an estimated per-flow power consumption of the modem for a communication flow associated with a particular application associated with the application processor, or
a predicted power consumption of the modem for a candidate communication flow.

4. The UE of claim 1, wherein the one or more processors, to determine the estimated power consumption, are configured to:
periodically determine the estimated power consumption based at least in part on a time period parameter.

5. The UE of claim 4, wherein the one or more processors, to periodically determine the estimated power consumption, are configured to:
determine the estimated power consumption across a plurality of consecutive slots that span a time period indicated by the time period parameter.

6. The UE of claim 4, wherein the one or more processors, to periodically determine the estimated power consumption, are configured to:
determine the estimated power consumption in each of a plurality of consecutive slots that span a time period indicated by the time period parameter.

7. The UE of claim 1, wherein the one or more processors, to determine the estimated power consumption, are configured to:
determine the estimated power consumption based at least in part on one or more power consumption parameters associated with the UE,
wherein the one or more power consumption parameters include at least one of:
a duplexing configuration for the UE,
a power saving configuration for the UE, or
one or more slot format types configured for the UE.

8. The UE of claim 7, wherein the one or more processors, to determine the estimated power consumption based at least in part on the one or more power consumption parameters, are configured to:
identify respective power consumption values for each component of the modem based at least in part on the one or more power consumption parameters; and
determine the estimated power consumption based at least in part on the respective power consumption values.

9. The UE of claim 8, wherein the one or more processors, to identify the respective power consumption values for each component of the modem, are configured to:
identify the respective power consumption values in a data structure stored by the UE.

10. The UE of claim 1, wherein the one or more processors, to determine the estimated power consumption, are configured to:
determine the estimated power consumption for a time period that includes a plurality of slots,
wherein the one or more processors, to determine the estimated power consumption for the time period, are configured to:
determine a respective percentage of slots occupied by each slot format that is used in the plurality of slots;
determine respective power values for each slot format that is used in the plurality of slots;
determine respective power consumption contributions for each slot format that is used in the plurality of slots based at least in part on the respective percentages and the respective power values; and
determine the estimated power consumption for the time period based at least in part on the respective power consumption contributions.

11. The UE of claim 10, wherein the one or more processors, to determine the respective percentage of slots occupied by each slot format that is used in the plurality of slots, are configured to:
determine first respective percentages of slots in which the UE operates in a high throughput mode, and that are occupied by each slot format that is used in the plurality of slots;
determine second respective percentages of slots in which the UE operates in a power saving mode, and that are occupied by each slot format that is used in the plurality of slots; and
determine third respective percentages of slots in which the UE operates in a transition mode between the high throughput mode and the power saving mode.

12. The UE of claim 11, wherein the one or more processors, to determine the respective power values for each slot format that is used in the plurality of slots, are configured to:
determine first respective power values, associated with the high throughput mode, for each slot format that is used in the plurality of slots;
determine second respective power values, associated with the power saving mode, for each slot format that is used in the plurality of slots; and
determine third respective power values associated with the transition mode.

13. The UE of claim 12, wherein the one or more processors, to determine the respective power consumption contributions for each slot format that is used in the plurality of slots, are configured to:
determine respective high throughput power consumption contributions for each slot format that is used in the plurality of slots based at least in part on the first respective percentages and the first respective power values;
determine respective power saving power consumption contributions for each slot format that is used in the plurality of slots based at least in part on the second respective percentages and the second respective power values; and
determine respective transition mode power consumption contributions based at least in part on the third respective percentages and the third respective power values.

14. The UE of claim 13, wherein the one or more processors, to determine the respective power saving power consumption contributions, are configured to:
determine the respective power saving power consumption contributions based at least in part on a type of sleep mode that is used in the plurality of slots by the UE.

15. The UE of claim 13, wherein the one or more processors, to determine the estimated power consumption for the time period, are configured to:
determine the estimated power consumption based at least in part on:
the respective high throughput power consumption contributions,
the respective power saving power consumption contributions, and
the respective transition mode power consumption contributions.

16. A method of wireless communication performed by a user equipment (UE), comprising:
determining, using a modem of the UE, an estimated power consumption of the modem; and
providing, using the modem, an indication of the estimated power consumption to an application processor of the UE.

17. The method of claim 16, wherein determining the estimated power consumption comprises:
determining the estimated power consumption for a time period that includes a plurality of slots,
wherein determining the estimated power consumption for the time period comprises:
determining a respective percentage of slots occupied by each slot format that is used in the plurality of slots;
determining respective power values for each slot format that is used in the plurality of slots;
determining respective power consumption contributions for each slot format that is used in the plurality of slots based at least in part on the respective percentages and the respective power values; and
determining the estimated power consumption for the time period based at least in part on the respective power consumption contributions.

18. The method of claim 17, wherein determining the respective percentages of slots occupied by each slot format that is used in the plurality of slots comprises:
determining, for a communication flow associated with an application that is executed by the application processor, the respective percentages of slots occupied by each slot format that is used in the plurality of slots;
wherein determining the respective power values for each slot format that is used in the plurality of slots comprises:
determining, for the communication flow, the respective power values for each slot format that is used in the plurality of slots;
wherein determining the respective power consumption contributions for each slot format that is used in the plurality of slots comprises:
determining, for the communication flow, the respective power consumption contributions for each slot format that is used in the plurality of slots; and
wherein determining the estimated power consumption comprises:
determining, for the communication flow, the estimated power consumption.

19. The method of claim 18, wherein determining the respective percentages of slots occupied by each slot format that is used in the plurality of slots for the communication flow comprises:
determining a quantity of physical downlink control channel (PDCCH) only slots in the plurality of slots;
determining a quantity of PDCCH and physical downlink shared channel (PDSCH) slots in the plurality of slots;
determining a quantity of physical uplink control channel (PUCCH) only slots in the plurality of slots;
determining a quantity of physical uplink shared channel (PUSCH) only slots in the plurality of slots;
determining a quantity of PUCCH and PUSCH slots in the plurality of slots; and
determining the respective percentages based at least in part on the quantity of PDSCH only slots, the quantity of PDCCH and PDSCH slots, the quantity of PUCCH only slots, the quantity of PUSCH only slots, and the quantity of PUCCH and PUSCH slots.

20. The method of claim 17, further comprising:
determining, for a candidate communication flow associated with an application that is executed by the application processor, respective predicted throughputs in another plurality of slots;
determining, for the candidate communication flow, respective predicted percentages of slots occupied by each slot format that is used in the other plurality of slots,
wherein the respective predicted percentages are based at least in part on the respective percentages and the respective predicted throughputs;
determining, for the candidate communication flow, respective predicted power values for each slot format that is used in the other plurality of slots;
determining, for the candidate communication flow, respective predicted power consumption contributions for each slot format that is used in the other plurality of slots,
wherein the respective predicted power consumption contributions are based at least in part on the respective predicted percentages and the respective predicted power values; and
determining, for the candidate communication flow, a predicted power consumption based at least in part on the respective predicted power consumption contributions.

21. The method of claim 20, wherein the predicted power consumption is based at least in part on a power saving mode of the UE.

22. A non-transitory computer-readable medium storing a set of instructions for wireless communication, the set of instructions comprising:
one or more instructions that, when executed by one or more processors of a user equipment (UE), cause the UE to:
determine, using a modem of the UE, an estimated power consumption of the modem; and
provide, using the modem, an indication of the estimated power consumption to an application processor of the UE.

23. The non-transitory computer-readable medium of claim 22, wherein the one or more instructions, that cause the UE to provide the indication of the estimated power consumption to the application processor of the UE, cause the UE to:
provide a periodic estimated power consumption report to the application processor of the UE,
provide a semi-periodic estimated power consumption report to the application processor of the UE,
provide an aperiodic estimated power consumption report to the application processor of the UE, or
provide event-triggered estimated power consumption reports to the application processor of the UE.

24. The non-transitory computer-readable medium of claim 22, wherein the one or more instructions further cause the UE to:
receive, at the modem and from the application processor, a periodicity for providing estimated power consumption reports; and
wherein the one or more instructions, that cause the UE to provide the indication of the estimated power consumption to the application processor of the UE, cause the UE to:
provide the estimated power consumption reports to the application processor of the UE based at least in part on the periodicity.

25. The non-transitory computer-readable medium of claim 22, wherein the one or more instructions, that cause the UE to provide the indication of the estimated power consumption to the application processor of the UE, cause the UE to:
provide the indication of the estimated power consumption to the application processor based at least in part on determining that a power consumption parameter satisfies a threshold; or
provide the indication of the estimated power consumption to the application processor based at least in part on determining that a power consumption reporting condition is satisfied.

26. The non-transitory computer-readable medium of claim 22, wherein the indication of the estimated power consumption comprises an explicit indication of an estimated power consumption value.

27. An apparatus for wireless communication, comprising:
means for determining, using a modem of the apparatus, an estimated power consumption of the modem; and
means for providing, using the modem, an indication of the estimated power consumption to an application processor of the apparatus.

28. The apparatus of claim 27, wherein the indication of the estimated power consumption comprises an indication of an estimated power consumption value relative to a standardized power consumption value.

29. The apparatus of claim 27, further comprising:
means for providing, from the modem to the application processor, an indication of at least one of:
an estimated pathloss between the apparatus and a network node, or
an estimated transmit power for the apparatus.

30. The apparatus of claim 27, wherein the indication of the estimated power consumption comprises:
an indication of an overall estimated power consumption of the modem, and
an indication of a plurality of estimated per-flow power consumptions of the modem for an associated plurality of communication flows associated with the application processor,
wherein each of the plurality of estimated per-flow power consumptions is indicated as a percentage of the overall estimated power consumption of the modem.
